(19) United States
(12) Patent Application Publication
(10) Pub. No.: US 2026/0236386 A1
(43) Pub. Date: Aug. 13, 2026

(54) STORAGE DEVICE FOR COMPRESSING AND STORING DATA AND METHOD OF OPERATION

(71) Applicant: SK hynix Inc., Icheon-si (KR)

(72) Inventor: In Jong JANG, Icheon-si (KR)

(21) Appl. No.: 19/236,619

(22) Filed: Jun. 12, 2025

(30) Foreign Application Priority Data
Feb. 12, 2025 (KR) 10-2025-0017828

(51) Int. Cl. G06F 12/02

(52) U.S. Cl. CPC G06F 12/0223; G06F 2212/1032

(57) ABSTRACT

A storage device may include a memory including a plurality of memory blocks; and a controller configured to, when detecting occurrence of a set event, compress target data stored in a first memory block among the plurality of memory blocks into compressed data, and store the compressed data in a second memory block among the plurality of memory blocks. The controller may store compression information indicating a progress state of a compression operation.

### CROSS-REFERENCE TO RELATED APPLICATION

The present application claims priority under 35 U.S.C. §119(a) to Korean Patent Application No. 10-2025-0017828 filed in the Korean Intellectual Property Office on Feb. 2, 2025, which is incorporated herein by reference in its entirety.

### BACKGROUND

### Technical Field

Embodiments of the present disclosure relate to a storage device for compressing and storing data and an operating method thereof.

### Related Art

A storage device is a device for storing data according to a request from an external device such as a computer, a mobile terminal (e.g., a smart phone or tablet), or the like.

A storage device may include a memory for storing data therein and a controller for controlling the memory. The memory may be a volatile memory or a non-volatile memory. The controller may receive a command from an external device (i.e., a host), and execute or control operations to read, write, or erase data in the memory included in the storage device according to the received command.

A part of data stored in the storage device may be read only a small number of times, but if a failure occurs during an operation of reading the corresponding data, then a serious problem may occur in the storage device.

### SUMMARY

Embodiments of the present disclosure are directed to providing a storage device and a method of operation capable of efficiently compressing target data whose integrity must be guaranteed and recovering the target data in emergency situations.

Objects of embodiments of the disclosure are not limited to those set forth herein, and other objects not mentioned here will be apparent to one of ordinary skill in the art from the following description.

In an embodiment, a storage device may include: a memory including a plurality of memory blocks; and a controller configured to, when detecting an occurrence of an event, compress target data stored in a first memory block among the plurality of memory blocks into compressed data, and store the compressed data in a second memory block from among the plurality of memory blocks. The controller may store compression information indicating a state of compression operation progress during a period when the target data is compressed and stored as the compressed data in the second memory block.

In an embodiment, a method for operating a storage device may include: monitoring for a set event; compressing, after detecting occurrence of the set event, target data stored in a first memory block from among a plurality of memory blocks into compressed data; storing the compressed data in a second memory block from among the plurality of memory blocks; and storing compression information indicating a progress state of a compression operation.

According to embodiments of the present disclosure, it is possible to provide a storage device and an operating method thereof capable of efficiently compressing target data whose integrity must be guaranteed and recovering the target data even in an emergency situation.

The effects of the disclosure are not limited to the foregoing effects, and other effects will be apparent to one of ordinary skill in the art from the following detailed description.

### BRIEF DESCRIPTION OF THE DRAWINGS

The disclosure will be more fully understood from the following detailed description and the accompanying drawings, which are provided for illustration only and are not intended to limit the disclosure.

FIG. 1 is a schematic configuration diagram of a storage device according to an embodiment of the present disclosure.

FIG. 2 is a block diagram schematically illustrating a memory of FIG. 1.

FIG. 3 is a diagram illustrating a schematic structure of a storage device according to an embodiment of the present disclosure.

FIG. 4 and FIG. 5 are diagrams illustrating an operation in which a storage device compresses target data according to an embodiment of the present disclosure.

FIG. 6 and FIG. 7 are diagrams illustrating an operation in which a storage device decompresses compressed data according to an embodiment of the present disclosure.

FIG. 8 is a diagram illustrating a method for operating a storage device according to an embodiment of the present disclosure.

### DETAILED DESCRIPTION

Hereinafter, embodiments of the disclosure are described in detail with reference to the accompanying drawings. In assigning reference numerals to components of each drawing, the same components may be assigned the same numerals even when they are shown on different drawings. When determined to make the subject matter of the disclosure unclear, details of the known art or functions may be skipped. As used herein, when a component “includes,” “has,” or “is composed of” another component, the component may add other components unless the component “only” includes, has, or is composed of the other component. As used herein, the singular forms “a”, “an” and “the” are intended to include the plural forms as well, unless the context clearly indicates otherwise.

Such denotations as "first," "second," "A," "B," "(a)," and "(b)," may be used in describing the components of the disclosure. These denotations are provided merely to distinguish a component from another, and the essence, order, or number of the components are not limited by the denotations.

In describing the positional relationship between components, when two or more components are described as "connected", "coupled" or "linked", the two or more components may be directly "connected", "coupled" or "linked", or another component may intervene. Here, the other component may be included in one or more of the two or more components that are “connected”, “coupled” or “linked” to each other.

When such terms as, e.g., “after”, “next”, “after”, and “before”, are used to describe the temporal flow relationship related to components, operation methods, and fabricating methods, it may include a non-continuous relationship unless the term “immediately” or “directly” is used.

When a component is designated with a value or its corresponding information (e.g., level), the value or the corresponding information may be interpreted as including a tolerance that may arise due to various factors (e.g., process factors, internal or external impacts, or noise).

Hereinafter, various embodiments of the disclosure are described in detail with reference to the accompanying drawings.

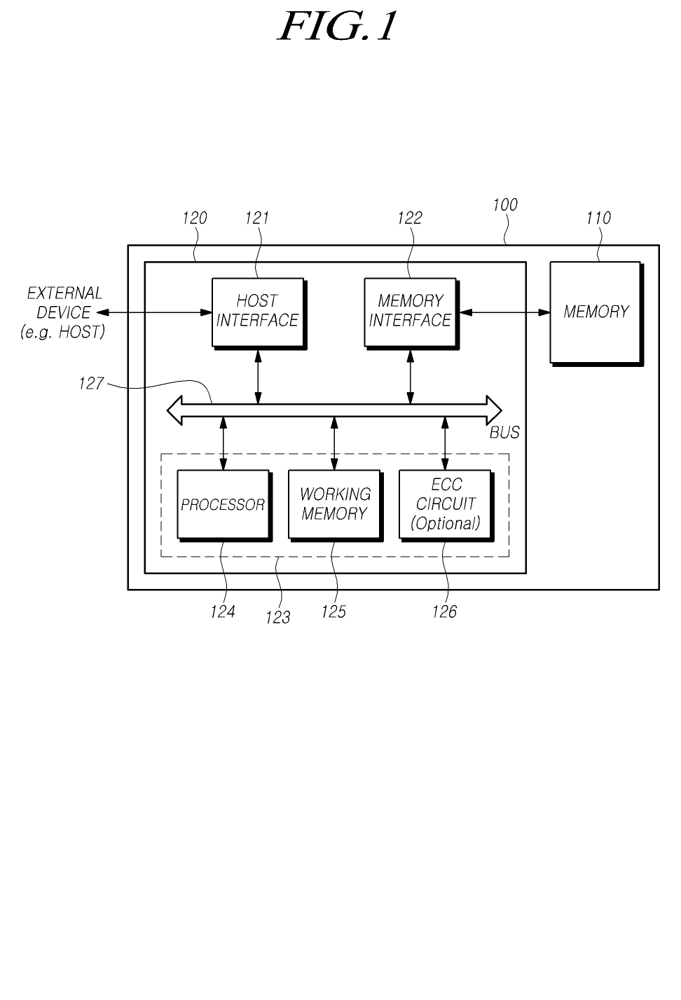

FIG. 1 is a schematic configuration diagram of a storage device according to an embodiment of the disclosure.

Referring to FIG. 1, a storage device 100 may include a memory 110 that stores data and a controller 120 that controls the memory 110.

The memory 110 includes a plurality of memory blocks, and operates in response to the control of the controller 120. Operations of the memory 110 may include, for example, a read operation, a program operation (also referred to as a write operation) and an erase operation.

The memory 110 may include a memory cell array including a plurality of memory cells (also simply referred to as “cells”) that store data.

For example, the memory 110 may be realized in various types of memory such as a DDR SDRAM (double data rate synchronous dynamic random access memory), an LPDDR4 (low power double data rate 4) SDRAM, a GDDR (graphics double data rate) SDRAM, an LPDDR (low power DDR), an RDRAM (Rambus dynamic random access memory), a NAND flash memory, a 3D NAND flash memory, a NOR flash memory, a resistive random access memory (RRAM), a phase-change memory (PRAM), a magnetoresistive random access memory (MRAM), a ferroelectric random access memory (FRAM) and a spin transfer torque random access memory (STT-RAM).

The memory 110 may be implemented as a three-dimensional array structure. For example, embodiments of the disclosure may be applied to a charge trap flash (CTF) in which a charge storage layer is configured by a dielectric layer and a flash memory in which a charge storage layer is configured by a conductive floating gate.

The memory 110 may receive a command and an address from the controller 120 and may access an area in the memory cell array that is selected by the address. In other words, the memory 110 may perform an operation indicated by the command, on the area selected by the address.

The memory 110 may perform a program operation, a read operation or an erase operation. For example, when performing the program operation, the memory 110 may program data to the area selected by the address. When performing the read operation, the memory 110 may read data from the area selected by the address. In the erase operation, the memory 110 may erase data stored in the area selected by the address.

The controller 120 may control write (program), read, erase and background operations for the memory 110. For example, background operations may include at least one from among a garbage collection (GC) operation, a wear leveling (WL) operation, a read reclaim (RR) operation, a bad block management (BBM) operation, and so forth.

The controller 120 may control the operation of the memory 110 according to a request from a device (e.g., a host) located outside the storage device 100. The controller 120, however, also may control the operation of the memory 110 regardless of a request of the host.

The host may be a computer, an ultra mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a computer network, one of various electronic devices configuring a telematics network, an RFID (radio frequency identification) device, and a mobility device (e.g., a vehicle, a robot or a drone) capable of driving under human control or autonomous driving, as non-limiting examples. Alternatively, the host may be a virtual reality (VR) device providing 2D or 3D virtual reality images or an augmented reality (AR) device providing augmented reality images. The host may be any one of various electronic devices that require the storage device 100 to be capable of storing data.

The host may include at least one operating system (OS). The operating system may generally manage and control the function and operation of the host, and may control interoperability between the host and the storage device 100. The operating system may be classified into a general operating system and a mobile operating system depending on the mobility of the host.

The controller 120 and the host may be devices that are separated from each other, or the controller 120 and the host may be integrated into one device. Hereunder, for the sake of convenience in explanation, descriptions will describe the controller 120 and the host as devices that are separated from each other.

Referring to FIG. 1, the controller 120 may include a memory interface 122 and a control circuit 123, and may further include a host interface 121.

The host interface 121 provides an interface for communication with the host. For example, the host interface 121 provides an interface that uses at least one from among various interface protocols such as a USB (universal serial bus) protocol, an MMC (multimedia card) protocol, a PCI (peripheral component interconnection) protocol, a PCI-E (PCI-express) protocol, an ATA (advanced technology attachment) protocol, a serial-ATA protocol, a parallel-ATA protocol, an SCSI (small computer system interface) protocol, an ESDI (enhanced small disk interface) protocol, an IDE (integrated drive electronics) protocol and a private protocol.

When receiving a command from the host, the control circuit 123 may receive the command through the host interface 121, and may perform an operation of processing the received command.

The memory interface 122 may be coupled with the memory 110 to provide an interface for communication with the memory 110. That is to say, the memory interface 122 may be configured to provide an interface between the memory 110 and the controller 120 in response to the control of the control circuit 123.

The control circuit 123 performs the general control operations of the controller 120 to control the operation of the memory 110. To this end, for instance, the control circuit 123 may include at least one of a processor 124 and a working memory 125, and may optionally include an error detection and correction circuit (ECC circuit) 126.

The processor 124 may control general operations of the controller 120, and may perform a logic calculation. The processor 124 may communicate with the host through the host interface 121, and may communicate with the memory 110 through the memory interface 122.

The processor 124 may execute logical operations required to perform the function of a flash translation layer (FTL). The processor 124 may translate a logical block address (LBA), provided by the host, into a physical block address (PBA) through the flash translation layer. The flash translation layer may receive the logical block address and translate the logical block address into the physical block address, by using a mapping table.

There are various address mapping methods of the flash translation layer, depending on a mapping unit. Representative address mapping methods include a page mapping method, a block mapping method and a hybrid mapping method.

The processor 124 may randomize data received from the host. For example, the processor 124 may randomize data received from the host by using a set randomizing seed. The randomized data may be provided to the memory 110, and may be programmed to a memory cell array of the memory 110.

In a read operation, the processor 124 may derandomize data received from the memory 110. For example, the processor 124 may derandomize data received from the memory 110 by using a derandomizing seed. The derandomized data may be outputted to the host.

The processor 124 may execute firmware to control the operation of the controller 120. Namely, in order to control the general operation of the controller 120 and perform a logic calculation, the processor 124 may execute (drive) firmware loaded in the working memory 125 upon booting. Hereafter, an operation of the storage device 100 according to embodiments of the disclosure will be described as implementing a processor 124 that executes firmware in which the corresponding operation is defined.

Firmware, as a program to be executed in the storage device 100 to drive the storage device 100, may include various functional layers. For example, the firmware may include binary data in which codes for executing the functional layers, respectively, are defined.

For example, the firmware may include at least one from among a flash translation layer, which performs a translating function between a logical address requested to the storage device 100 from the host and a physical address of the memory 110; a host interface layer (HIL), which serves to analyze a command requested to the storage device 100 as a storage device from the host and transfer the command to the flash translation layer; and a flash interface layer (FIL), which transfers a command, instructed from the flash translation layer, to the memory 110.

Such firmware may be loaded in the working memory 125 from, for example, the memory 110 or a separate nonvolatile memory (e.g., a ROM or a NOR Flash) located outside the memory 110. The processor 124 may first load all or a part of the firmware in the working memory 125 when executing a booting operation after power-on.

The processor 124 may perform a logic calculation, which is defined in the firmware loaded in the working memory 125, to control the general operation of the controller 120. The processor 124 may store a result of performing the logic calculation defined in the firmware, in the working memory 125. The processor 124 may control the controller 120 according to a result of performing the logic calculation defined in the firmware such that the controller 120 generates a command or a signal. When a part of firmware, in which a logic calculation to be performed is defined, is stored in the memory 110, but not loaded in the working memory 125, the processor 124 may generate an event (e.g., an interrupt) for loading the corresponding part of the firmware into the working memory 125 from the memory 110.

The processor 124 may load metadata necessary for driving firmware from the memory 110. The metadata, as data for managing the memory 110, may include for example management information on user data stored in the memory 110.

Firmware may be updated while the storage device 100 is manufactured or while the storage device 100 is operating. The controller 120 may download new firmware from the outside of the storage device 100 and update existing firmware with the new firmware.

To drive the controller 120, the working memory 125 may store necessary firmware, a program code, a command and data. The working memory 125 may be a volatile memory that includes, for example, at least one from among an SRAM (static RAM), a DRAM (dynamic RAM) and an SDRAM (synchronous DRAM). Meanwhile, the controller 120 may additionally use a separate volatile memory (e.g., SRAM, DRAM) located outside the controller 120 in addition to the working memory 125.

The error detection and correction circuit 126 may detect an error bit of target data, and correct the detected error bit by using an error correction code. The target data may be, for example, data stored in the working memory 125 or data read from the memory 110.

The error detection and correction circuit 126 may decode data by using an error correction code. The error detection and correction circuit 126 may be realized by various code decoders. For example, a decoder that performs unsystematic code decoding or a decoder that performs systematic code decoding may be used.

For example, the error detection and correction circuit 126 may detect an error bit by the unit of a set sector in each of the read data, when each read data is constituted by a plurality of sectors. A sector may mean a data unit that is smaller than a page, which is the read unit of a flash memory. Sectors constituting each read data may be matched with one another using an address.

The error detection and correction circuit 126 may calculate a bit error rate (BER), and may determine whether an error is correctable or not, by sector units. For example, when a bit error rate is higher than a reference value, the error detection and correction circuit 126 may determine that a corresponding sector is uncorrectable or a fail. On the other hand, when a bit error rate is lower than the reference value, the error detection and correction circuit 126 may determine that a corresponding sector is correctable or a pass.

The error detection and correction circuit 126 may perform an error detection and correction operation sequentially for all read data. In the case where a sector included in read data is correctable, the error detection and correction circuit 126 may omit an error detection and correction operation for a corresponding sector for next read data. If the error detection and correction operation for all read data is ended in this way, then the error detection and correction circuit 126 may detect a sector that is uncorrectable in read data last. There may be one or more sectors that are determined to be uncorrectable. The error detection and correction circuit 126 may transfer information (e.g., address information) regarding a sector that is determined to be uncorrectable to the processor 124.

A bus 127 may be configured to provide channels among the components 121, 122, 124, 125 and 126 of the controller 120. The bus 127 may include, for example, a control bus for transferring various control signals, commands and the like, a data bus for transferring various data, and so forth.

Some components among the above-described components 121, 122, 124, 125 and 126 of the controller 120 may be omitted, or some components among the above-described components 121, 122, 124, 125 and 126 of the controller 120 may be integrated into one component. In addition to the above-described components 121, 122, 124, 125 and 126 of the controller 120, one or more other components may be added.

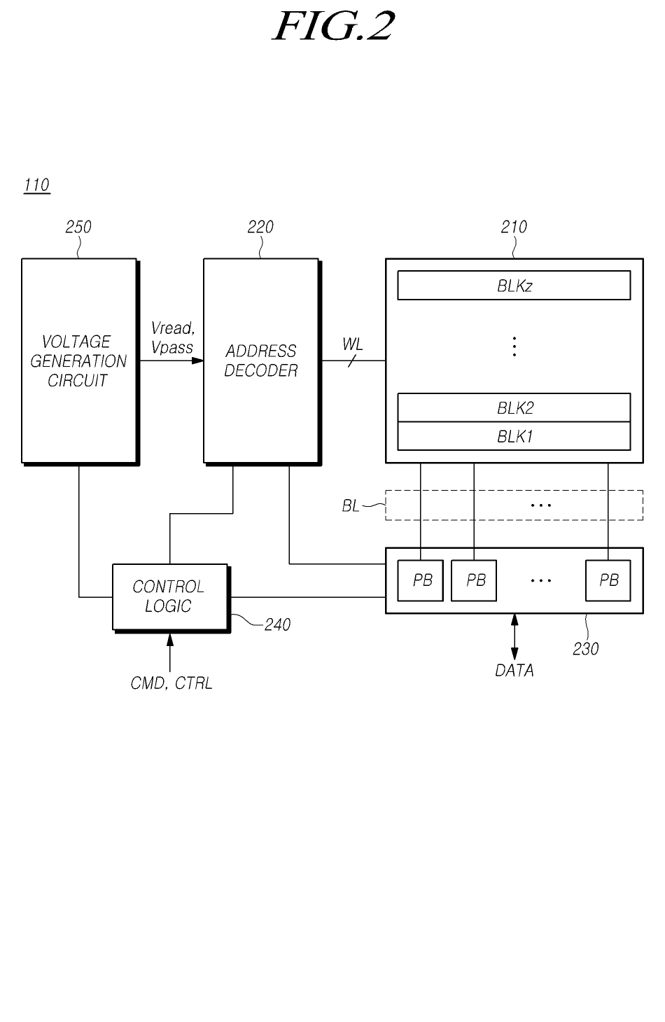

Hereinbelow, the memory 110 will be described in further detail with reference to FIG. 2.

FIG. 2 is a block diagram schematically illustrating a memory of FIG. 1.

Referring to FIG. 2, a memory 110 according to an embodiment of the disclosure may include a memory cell array 210, an address decoder 220, a read and write circuit 230, a control logic 240, and a voltage generation circuit 250.

The memory cell array 210 may include a plurality of memory blocks BLK1 to BLKz (where z is a natural number of 2 or greater).

In the plurality of memory blocks BLK1 to BLKz, a plurality of word lines WL and a plurality of bit lines BL may be disposed, and a plurality of memory cells may be arranged.

The plurality of memory blocks BLK1 to BLKz may be coupled with the address decoder 220 through the plurality of word lines WL. The plurality of memory blocks BLK1 to BLKz may be coupled with the read and write circuit 230 through the plurality of bit lines BL.

Each of the plurality of memory blocks BLK1 to BLKz may include a plurality of memory cells. For example, the plurality of memory cells may be nonvolatile memory cells, and may be configured by nonvolatile memory cells that have vertical channel structures.

The memory cell array 210 may be configured by a memory cell array of a two-dimensional structure or may be configured by a memory cell array of a three-dimensional structure.

Each of the plurality of memory cells included in the memory cell array 210 may store at least 1-bit data. For instance, each of the plurality of memory cells included in the memory cell array 210 may be a single level cell (SLC) that stores 1-bit data. In another instance, each of the plurality of memory cells included in the memory cell array 210 may be a multi-level cell (MLC) that stores 2-bit data. In still another instance, each of the plurality of memory cells included in the memory cell array 210 may be a triple level cell (TLC) that stores 3-bit data. In yet another instance, each of the plurality of memory cells included in the memory cell array 210 may be a quad level cell (QLC) that stores 4-bit data. In a further instance, the memory cell array 210 may include a plurality of memory cells, each of which stores 5 or more-bit data.

The number of bits of data stored in each of the plurality of memory cells may be dynamically determined. For example, a single-level cell that stores 1-bit data may be changed to a triple-level cell that stores 3-bit data.

Referring to FIG. 2, the address decoder 220, the read and write circuit 230, the control logic 240 and the voltage generation circuit 250 may operate as a peripheral circuit that drives the memory cell array 210.

The address decoder 220 may be coupled to the memory cell array 210 through the plurality of word lines WL.

The address decoder 220 may be configured to operate in response to the control of the control logic 240.

The address decoder 220 may receive an address through an input/output buffer in the memory 110. The address decoder 220 may be configured to decode a block address in the received address. The address decoder 220 may select at least one memory block depending on the decoded block address.

The address decoder 220 may receive a read voltage Vread and a pass voltage Vpass from the voltage generation circuit 250.

The address decoder 220 may apply the read voltage Vread to a selected word line WL in a selected memory block during a read operation, and may apply the pass voltage Vpass to the remaining unselected word lines WL.

The address decoder 220 may apply a verify voltage generated in the voltage generation circuit 250 to a selected word line WL in a selected memory block in a program verify operation, and may apply the pass voltage Vpass to the remaining unselected word lines WL.

The address decoder 220 may be configured to decode a column address in the received address. The address decoder 220 may transmit the decoded column address to the read and write circuit 230.

A read operation and a program operation of the memory 110 may be performed by the unit of a page. An address received when a read operation or a program operation is requested may include at least one from among a block address, a row address and a column address.

The address decoder 220 may select one memory block and one word line depending on a block address and a row address. A column address may be decoded by the address decoder 220 and be provided to the read and write circuit 230.

The address decoder 220 may include at least one from among a block decoder, a row decoder, a column decoder and an address buffer.

The read and write circuit 230 may include a plurality of page buffers PB. The read and write circuit 230 may operate as a read circuit in a read operation of the memory cell array 210, and may operate as a write circuit in a write operation of the memory cell array 210.

The read and write circuit 230 described above may also be referred to as a page buffer circuit or a data register circuit that includes a plurality of page buffers PB. The read and write circuit 230 may include data buffers that take charge of a data processing function, and may further include cache buffers that take charge of a caching function.

The plurality of page buffers PB may be coupled to the memory cell array 210 through the plurality of bit lines BL. The plurality of page buffers PB may continuously supply sensing current to bit lines BL coupled with memory cells to sense threshold voltages (Vth) of the memory cells in a read operation and a program verify operation, and may latch sensing data by sensing, through sensing nodes, changes in the amounts of current flowing, depending on the programmed states of the corresponding memory cells.

The read and write circuit 230 may operate in response to page buffer control signals outputted from the control logic 240.

In a read operation, the read and write circuit 230 temporarily stores read data by sensing data of memory cells, and then, outputs data DATA to the input/output buffer of the memory 110. As an exemplary embodiment, the read and write circuit 230 may include a column select circuit in addition to the page buffers PB or the page registers.

The control logic 240 may be coupled with the address decoder 220, the read and write circuit 230 and the voltage generation circuit 250. The control logic 240 may receive a command CMD and a control signal CTRL through the input/output buffer of the memory 110.

The control logic 240 may be configured to control general operations of the memory 110 in response to the control signal CTRL. The control logic 240 may output control signals for adjusting the precharge potential levels of the sensing nodes of the plurality of page buffers PB.

The control logic 240 may control the read and write circuit 230 to perform a read operation of the memory cell array 210. The voltage generation circuit 250 may generate the read voltage Vread and the pass voltage Vpass used in a read operation, in response to a voltage generation circuit control signal outputted from the control logic 240.

Each memory block of the memory 110 described above may be configured by a plurality of pages corresponding to a plurality of word lines WL and a plurality of strings corresponding to a plurality of bit lines BL.

In a memory block BLK, a plurality of word lines WL and a plurality of bit lines BL may be disposed to intersect with each other. For example, each of the plurality of word lines WL may be disposed in a row direction, and each of the plurality of bit lines BL may be disposed in a column direction. In another example, each of the plurality of word lines WL may be disposed in a column direction, and each of the plurality of bit lines BL may be disposed in a row direction.

A memory cell may be coupled to one of the plurality of word lines WL and one of the plurality of bit lines BL. A transistor may be disposed in each memory cell.

For example, a transistor disposed in each memory cell may include a drain, a source, and a gate. The drain (or source) of the transistor may be coupled with a corresponding bit line BL directly or via another transistor. The source (or drain) of the transistor may be coupled with a source line (which may be the ground) directly or via another transistor. The gate of the transistor may include a floating gate, which is surrounded by a dielectric, and a control gate to which a gate voltage is applied from a word line WL.

In each memory block, a first select line (also referred to as a source select line or a drain select line) may be additionally disposed outside a first outermost word line more adjacent to the read and write circuit 230 between two outermost word lines, and a second select line (also referred to as a drain select line or a source select line) may be additionally disposed outside a second outermost word line between the two outermost word lines.

At least one dummy word line may be additionally disposed between the first outermost word line and the first select line. At least one dummy word line may also be additionally disposed between the second outermost word line and the second select line.

A read operation and a program operation (write operation) of the memory block described above may be performed by the unit of a page, and an erase operation may be performed by the unit of a memory block.

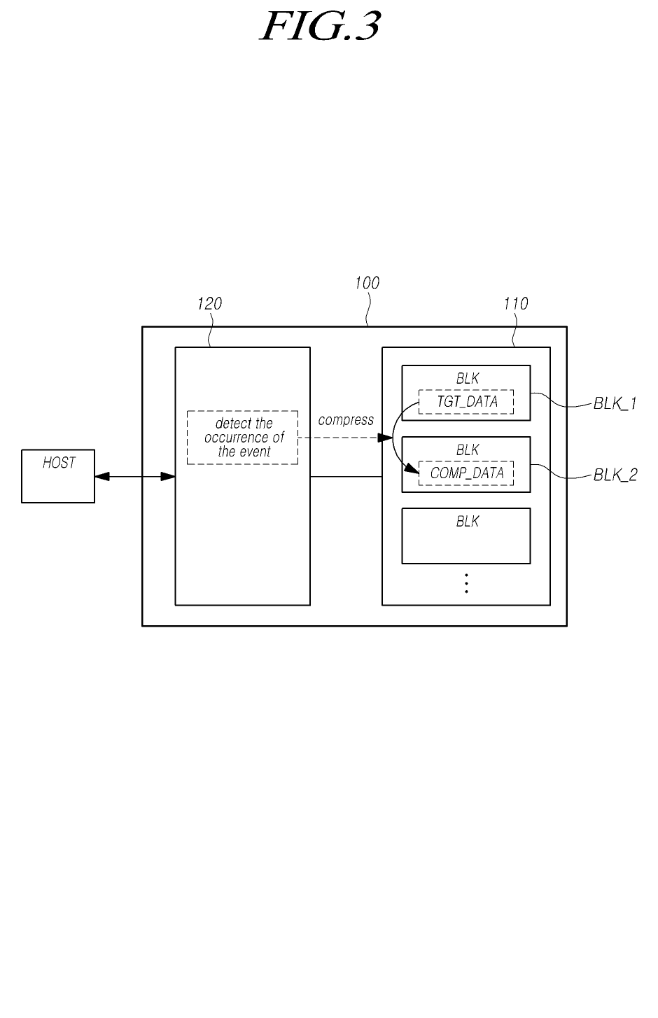

FIG. 3 is a diagram illustrating a schematic structure of a storage device according to an embodiment of the present disclosure.

Referring to FIG. 3, a storage device 100 may include a memory 110 and a controller 120.

The memory 110 may include a plurality of memory blocks BLK. Each of the plurality of memory blocks BLK may store data.

The controller 120 may detect the occurrence of an event by monitoring for a set event. The event may occur inside or outside the storage device 100.

During the course of monitoring, when a set event occurs, the controller 120 may compress target data TGT_DATA stored in a first memory block BLK_1, from among the plurality of memory blocks BLK into compressed data COMP_DATA, and may store the compressed data COMP_DATA in a second memory block BLK_2 from among the plurality of memory blocks BLK. The second memory block BLK_2 may be different from the first memory block BLK_1 or may be identical to the first memory block BLK_1.

In embodiments of the present disclosure, the target data TGT_DATA may be data that must be read during an operation of the storage device 100. Even though the number of times the target data TGT_DATA is read may be small, the target data TGT_DATA may be data whose integrity needs to be guaranteed during a read operation.

Because the target data TGT_DATA is data that is used only in a specific situation, the target data TGT_DATA may be stored in the normal course as compressed data to reduce the size of the required storage space, and may be read by being decompressed only when the target data TGT_DATA is needed.

For example, the target data TGT_DATA may be e-fuse data or a query descriptor.

E-fuse data may be data read from an e-fuse memory (in which, once data is programmed to a specific location, the corresponding data cannot be changed further), and may be used only in a booting operation of the storage device 100.

The query descriptor is information used to set the state of the storage device 100 and may be used when the storage device 100 executes a logical unit configuring operation according to a Universal Flash Storage (UFS).

Referring again to FIG. 3, the event may be a power-off notification as an example.

In another example, the target data TGT_DATA may be data that is a target of garbage collection. The target data TGT_DATA that is a target of garbage collection may be valid data from among data stored in a victim memory block.

When target data TGT_DATA is a target of garbage collection, the event of FIG. 3 may be indicted by at least one of 1) a power-off notification; 2) a throttling notification or a shutdown notification for the storage device 100; 3) a notification indicating that an emergency background operation (e.g., garbage collection, wear leveling or read reclaim) on the storage device 100 is required; and 4) a notification indicating that the number of free memory blocks among the plurality of memory blocks BLK is equal to or smaller than a threshold number.

When the event occurs, since there is a possibility that a failure occurs in the target data TGT_DATA during a garbage collection operation, compression may be performed to back up the target data TGT_DATA.

In the embodiments of the present disclosure, it has been described that the target data TGT_DATA is data that is read a small number of times. However, in other embodiments when a compression operation on the target data TGT_DATA needs to be executed quickly, data that is read a larger number of times may be determined as the target data TGT_DATA.

For instance, the target data TGT_DATA may be mapping data that indicates the mapping relationship between a logical address and a physical address.

In another example, the target data TGT_DATA may be firmware to be driven by the controller 120. The firmware may be stored in a preset firmware backup block from among the plurality of memory blocks BLK.

In still another example, the target data TGT_DATA may be data that is stored in a memory block as a target of an unmap/trim operation.

When compressing the target data TGT_DATA into the compressed data COMP_DATA, the controller 120 may use various compression algorithms.

For example, the controller 120 may compress the target data TGT_DATA into a compressed data COMP_DATA using a run-length encoding (RLE) algorithm or a Huffman coding algorithm.

For example, when using the RLE algorithm, the controller 120 may determine a result of compressing the target data TGT_DATA depending on the number of consecutive 0s or 1s.

For example, whether consecutive data bits are 0 or 1 is expressed by the most significant bit (MSB) of a byte, and the remaining seven bits of the byte may express the number of consecutive 0s or 1s. When data is 0xFF (i.e., eight consecutive 1s), compression is performed resulting in a 10001000 in binary number. When data is 0xFFFF (i.e., 16 consecutive 1s), compression is performed resulting in a 10010000 in binary number. When data is 0xF00F (i.e., four consecutive 1s / eight consecutive 0s / four consecutive 1s), compression is performed resulting in a 100001000000100010000100 in binary number.

When a read operation on data occurs frequently, and compression and decompression are repeated, performance degradation results. Therefore, it is advantageous that the compression algorithm described above is applied to data on which a read operation does not occur frequently.

In addition, when the target data TGT_DATA is compressed using the compression algorithm described above, parity may be stored efficiently as well. The existing parity storage method performs an XOR operation on all data bits to store whether data bits of each preset unit size (e.g., WL) are odd/even. However, when storing parity after compressing the target data TGT_DATA, an XOR operation may be quickly performed with only an MSB and an LSB.

For example, when generating the parity of compressed data, since a portion (one byte) in the compressed data, where an MSB is 0, is data that has consecutive 0s and may be determined as even, a parity calculation process may be passed.

Therefore, a parity calculation process needs to be performed only for a portion where the MSB is 1. Because an odd number of 1s exist only when an MSB is 1 and an LSB is 1, parity may be generated by performing an XOR operation only on a portion where both an MSB and an LSB are 1.

Moreover, even in a case where parity is checked to see whether there is a change in compressed data, whether a bit flip has occurred may be checked by performing an XOR operation only on a portion where both an MSB and an LSB are 1.

Furthermore, a checksum may also be generated efficiently. In compressed data, a portion where an MSB is 0 means that all data are 0, and therefore, the value of a checksum for the corresponding portion is 0. When an MSB is 1, a checksum may be generated by consecutively adding 1 to remaining data excluding the MSB. Thus, a checksum may also be generated more quickly.

In addition, data security may be strengthened by compressing the target data TGT_DATA. After compressing the target data TGT_DATA, by storing compressed data by evenly distributing the numbers of 0s and 1s through a randomizer, the number of data transformation stages increases, which may strengthen data security. As a result, the reliability of the target data TGT_DATA may be increased.

In embodiments of the present disclosure, during a period when the target data TGT_DATA is compressed into the compressed data COMP_DATA and stored in the second memory block BLK_2, the controller 120 of the storage device 100 may store compression information indicating the state of progress of a compression operation. The compression information may be stored outside or inside the controller 120.

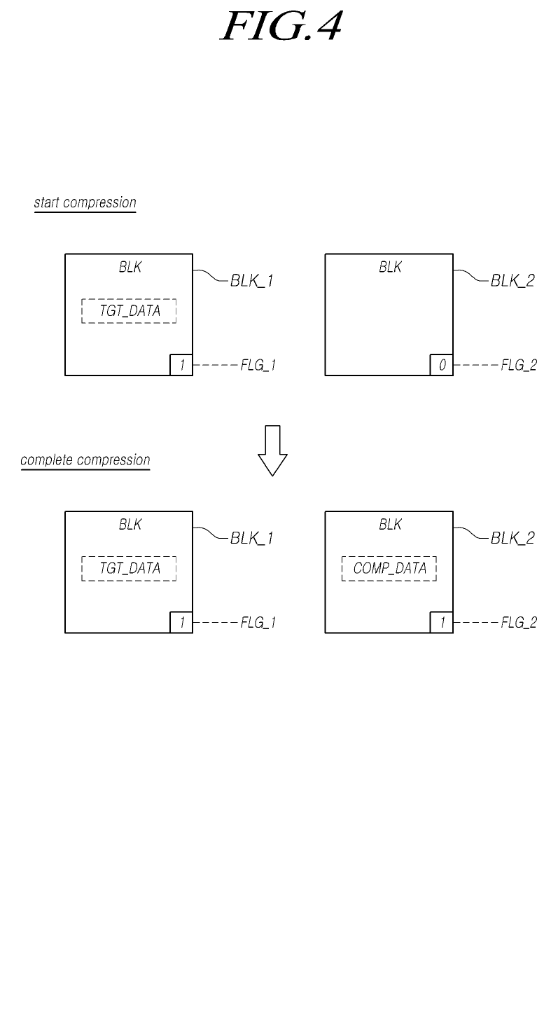

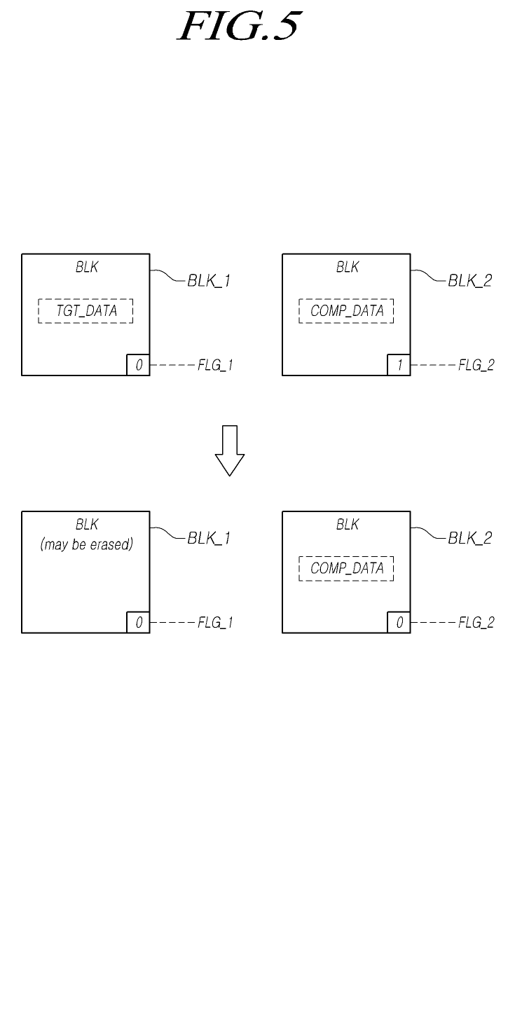

For example, the compression information may be a first flag FLG_1 corresponding to the first memory block BLK_1 and a second flag FLG_2 corresponding to the second memory block BLK_2. Hereinafter, this will be described in detail with reference to FIG. 4 and FIG. 5.

FIG. 4 and FIG. 5 are diagrams illustrating an operation in which a storage device compresses target data according to an embodiment of the present disclosure.

Referring to FIG. 4, when starting an operation of compressing target data TGT_DATA into compressed data COMP_DATA, a controller 120 of a storage device 100 may set a first flag FLG_1 corresponding to a first memory block BLK_1 to a first value (e.g., 1).

The first flag FLG_1 may be used as a checkpoint for checking the state of compression progress for the target data TGT_DATA.

For example, the first flag FLG_1 may be located in a page information (PI) area corresponding a last page (i.e., a page that is last written when data is written to the first memory block BLK_1) from among a plurality of pages included in the first memory block BLK_1. The PI area may be a spare area where user data is not stored, and instead where additional information such as information about the page is stored.

In another example, the first flag FLG_1 may be located in a PI area corresponding to one of the pages in which the target data TGT_DATA is stored, from among the plurality of pages included in the first memory block BLK_1.

In FIG. 4, a first flag FLG_1 is illustrated inside the first memory block BLK_1 as an example, but in other examples the first flag FLG_1 may be located outside the first memory block BLK_1.

For example, the first flag FLG_1 may be stored in a separate memory block, from among the plurality of memory blocks BLK, that is allocated to store flag information.

In another example, the first flag FLG_1 may be stored in a separate volatile or nonvolatile memory included inside the storage device 100.

FIG. 4 illustrates an example in which the first value is 1, but the first value does not necessarily have to be expressed as 1-bit data (0 or 1). The first value may be expressed as data in a different format (e.g., as the address of a second memory block BLK_2 where the compressed data COMP_DATA is stored).

After the operation of storing the compressed data COMP_DATA in the second memory block BLK_2 is completed, the controller 120 may set a second flag FLG_2 corresponding to the second memory block BLK_2 to the first value (e.g., 1).

Like the first flag FLG_1, the second flag FLG_2 may also be used as a checkpoint for checking the status of compression progress for the target data TGT_DATA.

For example, the second flag FLG_2 may be located in a page information (PI) area corresponding to a last page from among a plurality of pages included in the second memory block BLK_2.

In another example, the second flag FLG_2 may be located in a PI area corresponding to one of pages in which the compressed data COMP_DATA is stored, from among the plurality of pages included in the second memory block BLK_2.

Referring to FIG. 5, after setting the second flag FLG_2 to the first value, the controller 120 may set the first flag FLG_1 to a second value (e.g., 0).

After setting the first flag FLG_1 to the second value, the controller 120 may set the second flag FLG_2 to the second value. Thereafter, the controller 120 may additionally execute an erase operation on the first memory block BLK_1.

When the controller 120 sets the first flag FLG_1 and the second flag FLG_2 as described above with reference to FIG. 4 and FIG. 5, even when a compression operation is suspended due to a sudden power-off (SPO), an interrupt service routine (ISR), an emergency operation, a high priority operation, etc. in the process of compressing the target data TGT_DATA, the compression operation may be efficiently completed without wasting a memory block.

For example, when an SPO occurs in the process of compressing the target data TGT_DATA, values of the first flag FLG_1 and the second flag FLG_2 may be checked in a subsequent sudden power-off recovery (SPOR) process to determine the stage in the operation of compressing the target data TGT_DATA. Therefore, it is possible to prevent the waste of a memory block that occurs when the operation of compressing the target data TGT_DATA is unconditionally restarted from the beginning.

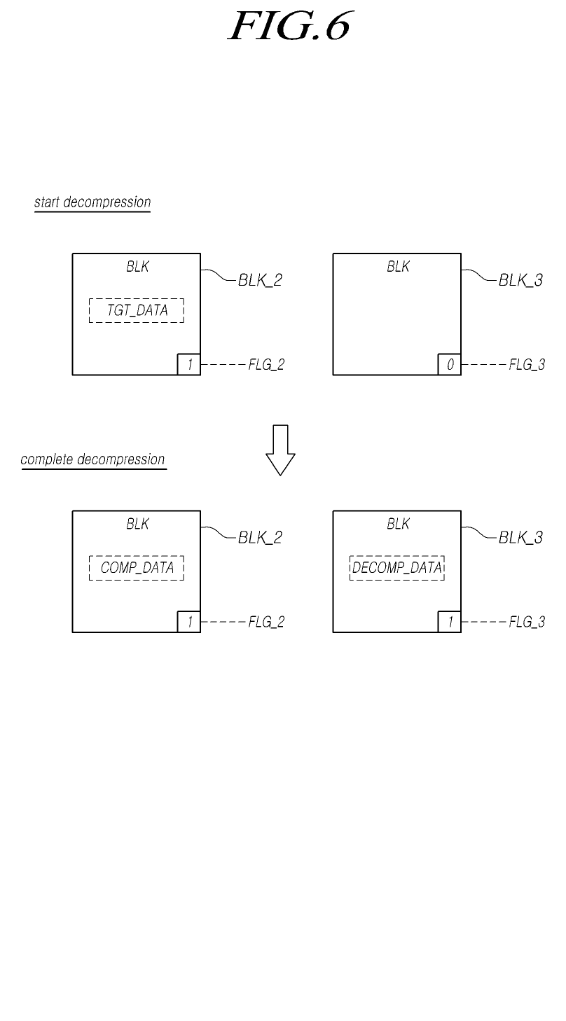

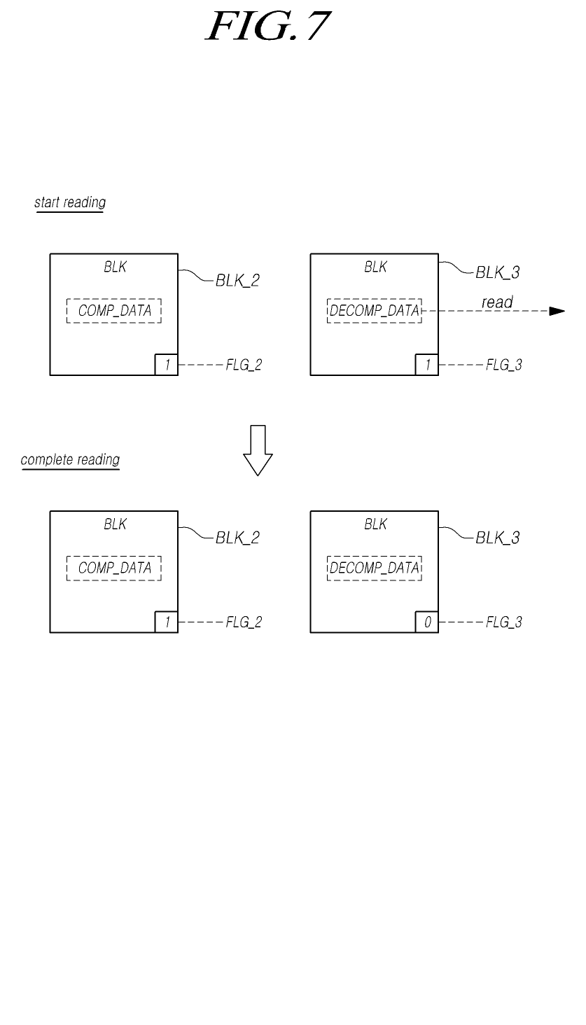

FIG. 6 and FIG. 7 are diagrams illustrating an operation in which a storage device decompresses compressed data according to an embodiment of the present disclosure.

Referring to FIG. 6, when starting a decompression operation on compressed data COMP_DATA stored in a second memory block BLK_2, a controller 120 of a storage device 100 may set a second flag FLG_2 corresponding to the second memory block BLK_2 to a first value (e.g., 1).

The controller 120 may decompress the compressed data COMP_DATA into decompressed data DECOMP_DATA, and may store the decompressed data DECOMP_DATA in a third memory block BLK_3 from among the plurality of memory blocks BLK. When the decompression works normally, the decompressed data DECOMP_DATA is identical to the target data TGT_DATA.

The third memory block BLK_3 may be a memory block identical to the first memory block BLK_1 described above or may be a different memory block.

After the operation of storing the decompressed data DECOMP_DATA in the third memory block BLK_3 is completed, the controller 120 may set a third flag FLG_3 corresponding to the third memory block BLK_3 to the first value.

For example, the third flag FLG_3 may be located in a page information (PI) area corresponding to a last page from among a plurality of pages included in the third memory block BLK_3.

In another example, the third flag FLG_3 may be located in a PI area corresponding to one of pages in which the decompressed data DECOMP_DATA is stored from among the plurality of pages included in the third memory block BLK_3.

Referring to FIG. 7, the controller 120 may read the decompressed data DECOMP_DATA stored in the third memory block BLK_3.

After the operation of reading the decompressed data DECOMP_DATA is completed, the controller 120 may set the third flag FLG_3 to the second value.

After setting the third flag FLG_3 to the second value, the controller 120 may additionally execute an operation of setting the second flag FLG_2 to the second value.

When the controller 120 sets the second flag FLG_2 and the third flag FLG_3 as described above with reference to FIG. 6 and FIG. 7, even when a decompression operation is suspended due to a sudden power-off (SPO), an interrupt service routine (ISR), an emergency operation, a high priority operation, etc. in the process of decompressing the compressed data COMP_DATA, the decompression operation may be efficiently completed without wasting a memory block.

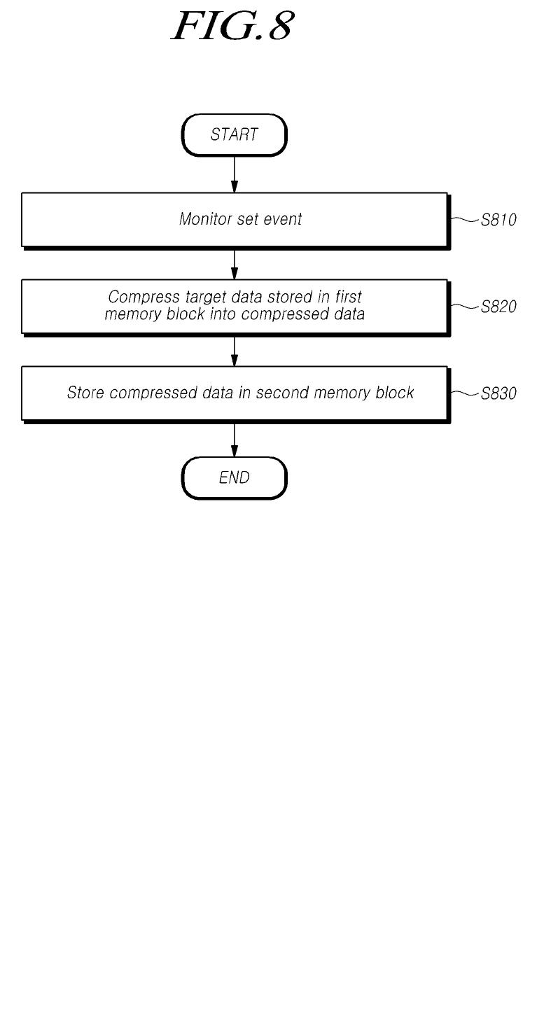

FIG. 8 is a diagram illustrating a method for operating a storage device 100 according to an embodiment of the present disclosure.

Referring to FIG. 8, a method for operating a storage device 100 may include step S810 of monitoring for a set event.

The method for operating the storage device 100 may include step S820 of compressing, after detecting the occurrence of the set event, target data TGT_DATA stored in a first memory block BLK_1, from among a plurality of memory blocks BLK, into compressed data COMP_DATA.

For example, the target data TGT_DATA may be e-fuse data or a query descriptor, and the set event may be a power-off notification.

In another example, the target data TGT_DATA may be data that is a target of garbage collection and, the event may indicate at least one of a power-off notification, a throttling notification or a shutdown notification for the storage device 100, a notification indicating that an emergency background operation on the storage device 100 is required, and a notification indicating that the number of free memory blocks among the plurality of memory blocks BLK is equal to or smaller than a threshold number.

The method for operating the storage device 100 may include step S830 of storing the compressed data COMP_DATA in a second memory block BLK_2 from among the plurality of memory blocks BLK.

The steps S820 and S830 may store compression information indicating the progress states of the compression operation.

For example, the compression information may include a first flag FLG_1 corresponding to the first memory block BLK_1 and a second flag FLG_2 corresponding to the second memory block BLK_2.

For example, the first flag FLG_1 may be located in a page information (PI) area corresponding to a last page from among a plurality of pages included in the first memory block BLK_1.

For example, the second flag FLG_2 may be located in a PI area corresponding to a last page from among a plurality of pages included in the second memory block BLK_2.

The first flag FLG_1 may be set to a second value after the second flag FLG_2 is set to a first value.

The second flag FLG_2 may be set to the second value after the first flag FLG_1 is set to the second value.

The method for operating the storage device 100 may further include the step of decompressing the compressed data COMP_DATA into decompressed data DECOMP_DATA. The decompressing step may include a step of setting, when starting a decompression operation on the compressed data COMP_DATA, the second flag FLG_2 corresponding to the second memory block BLK_2 to the first value; a step of storing the decompressed data DECOMP_DATA in a third memory block BLK_3 among the plurality of memory blocks BLK; and a step of setting, after an operation of storing the decompressed data DECOMP_DATA in the third memory block BLK_3 is completed, a third flag FLG_3 corresponding to the third memory block BLK_3 to the first value.

For example, the method for operating the storage device 100 may further include step of reading the decompressed data DECOMP_DATA; and step of setting, after an operation of reading the decompressed data DECOMP_DATA is completed, the third flag FLG_3 to the second value.

Although exemplary embodiments of the disclosure have been described for illustrative purposes, those skilled in the art will appreciate that various modifications, additions and substitutions are possible, without departing from the scope and spirit of the disclosure. Therefore, the embodiments disclosed above and in the accompanying drawings should be considered in a descriptive sense only and not for limiting the technological scope. The technological scope of the disclosure is not limited by the embodiments and the accompanying drawings. The spirit and scope of the disclosure should be interpreted in connection with the appended claims and encompass all equivalents falling within the scope of the appended claims.

What is claimed is:

1. A storage device comprising:
a memory including a plurality of memory blocks; and
a controller configured to, when detecting an occurrence of an event, compress target data stored in a first memory block from among the plurality of memory blocks into compressed data, and store the compressed data in a second memory block from among the plurality of memory blocks,
wherein the controller stores compression information indicating a state of compression operation progress during a period when the target data is compressed and stored as the compressed data in the second memory block.

2. The storage device according to claim 1, wherein the target data is e-fuse data or a query descriptor.

3. The storage device according to claim 2, wherein the event is a power-off notification.

4. The storage device according to claim 1, wherein the target data is data that is a target of garbage collection.

5. The storage device according to claim 4, wherein the event indicates at least one of a power-off notification, a throttling notification or a shutdown notification for the storage device, a notification indicating that an emergency background operation on the storage device is required, and a notification indicating that the number of free memory blocks from among the plurality of memory blocks is equal to or smaller than a threshold number.

6. The storage device according to claim 1,
wherein the compression information includes a first flag corresponding to the first memory block and a second flag corresponding to the second memory block, and
wherein the controller
sets, when starting an operation of compressing the target data into the compressed data, the first flag to a first value,
sets, after an operation of storing the compressed data in the second memory block is completed, the second flag to the first value,
sets, after setting the second flag to the first value, the first flag to a second value, and
sets, after setting the first flag to the second value, the second flag to the second value.

7. The storage device according to claim 6, wherein the first value is an address of the second memory block.

8. The storage device according to claim 6, wherein
the first flag is located in a page information (PI) area corresponding to a last page from among a plurality of pages included in the first memory block, and
the second flag is located in a PI area corresponding to a last page from among a plurality of pages included in the second memory block.

9. The storage device according to claim 1, wherein the controller compresses the target data into the compressed data using a run-length encoding (RLE) algorithm or a Huffman coding algorithm.

10. The storage device according to claim 6, wherein the controller
sets, when starting a decompression operation on the compressed data, the second flag corresponding to the second memory block to the first value,
decompresses the compressed data into decompressed data,
stores the decompressed data in a third memory block from among the plurality of memory blocks, and
sets, after an operation of storing the decompressed data in the third memory block is completed, a third flag corresponding to the third memory block to the first value.

11. The storage device according to claim 10, wherein the controller
reads the decompressed data, and
sets, after an operation of reading the decompressed data is completed, the third flag to the second value.

12. A method for operating a storage device, comprising:
monitoring for a set event;
compressing, after detecting occurrence of the set event, target data stored in a first memory block from among a plurality of memory blocks into compressed data;
storing the compressed data in a second memory block from among the plurality of memory blocks; and
storing compression information indicating a progress state of a compression operation.

13. The method according to claim 12, wherein the target data is e-fuse data or a query descriptor.

14. The method according to claim 13, wherein the set event is a power-off notification.

15. The method according to claim 12, wherein the target data is data that is a target of garbage collection.

16. The method according to claim 15, wherein the set event indicates at least one of a power-off notification, a throttling notification or a shutdown notification for the storage device, a notification indicating that an emergency background operation on the storage device is required, and a notification indicating that the number of free memory blocks from among the plurality of memory blocks is equal to or smaller than a threshold number.

17. The method according to claim 12, wherein
the compression information includes a first flag corresponding to the first memory block and a second flag corresponding to the second memory block, and the method further comprises
setting the first flag to a first value when starting an operation of compressing the target data into the compressed data,
setting the second flag to the first value after an operation of storing the compressed data in the second memory block is completed,
setting the first flag to a second value after the second flag is set to the first value, and
setting the second flag to the second value after the first flag is set to the second value.

18. The method according to claim 17, wherein the first value is an address of the second memory block.

19. The method according to claim 17, wherein
the first flag is located in a page information (PI) area corresponding to a last page from among a plurality of pages included in the first memory block, and
the second flag is located in a PI area corresponding to a last page from among a plurality of pages included in the second memory block.

20. The method according to claim 17, further comprising
decompressing the compressed data into decompressed data,
wherein the decompressing comprises:
setting, when starting a decompression operation on the compressed data, the second flag corresponding to the second memory block to the first value;
storing the decompressed data in a third memory block from among the plurality of memory blocks; and
setting, after an operation of storing the decompressed data in the third memory block is completed, a third flag corresponding to the third memory block to the first value.
